(19) United States
(12) Patent Application Publication
(10) Pub. No.: US 2012/0036857 A1
(43) Pub. Date: Feb. 16, 2012

(54) COMBUSTION LINER STOP BLOCKS HAVING INSERTABLE WEAR FEATURES AND RELATED METHODS

(75) Inventor: Scott Bryan Bassani, Fountain Inn, SC (US)

(73) Assignee: GENERAL ELECTRIC COMPANY, Schenectady, NY (US)

(21) Appl. No.: 12/853,366

(22) Filed: Aug. 10, 2010

(51) Int. Cl. F02C 1/00; B23P 19/00

(52) U.S. Cl. 60/752; 29/700

(57) ABSTRACT

A combustion liner stop block having insertable wear features and methods for installing wear features within a combustion liner stop block are disclosed. The methods may generally include enlarging a slot defined in the liner stop block to form a cavity, locating an insert block in the cavity and providing at least one wear feature associated with the insert block.

### FIELD OF THE INVENTION

The present subject matter relates generally to combustion liner stops of gas turbine combustors and particularly to combustion liner stop blocks having insertable wear features and related methods.

### BACKGROUND OF THE INVENTION

Gas turbines typically include a compressor section, a combustion section, and a turbine section. The compressor section pressurizes air flowing into the turbine. The pressurized air discharged from the compressor section flows into the combustion section, which is generally characterized by a plurality of combustors disposed around an annular array about the axis of the gas turbine. Each of the plurality of combustors includes a combustion liner, which defines the combustion chamber of the combustor. As such, air entering each combustor is mixed with fuel and combusted within the combustion liner. Hot combustion gases flow from the combustion liner through a transition piece to the turbine section of the gas turbine to drive the turbine and generate power.

The combustion liner of a gas turbine combustor is typically concentrically located within a flow sleeve of the combustor and radially inwardly spaced therefrom. The forward end of the combustion liner is generally provided with a plurality of circumferentially spaced liner stop tabs (i.e., male liner stops) which cooperate and/or mate with a corresponding number of liner stop blocks (i.e., female liner stops) secured to the flow sleeve or, in some embodiments, the combustion casing. As such, when the combustion liner is installed within the flow sleeve, the liner stops ensure proper radial and axial location of the combustion liner within the flow sleeve and also prevent the combustion liner from moving in an axially downstream direction (i.e., towards the transition piece).

The combustion liner stops generally support the combustion liner during the extreme vibration and heat produced by the combustion process occurring within the combustor. Often, vibration and thermal deformations resulting from combustion cause the combustion liner, the flow sleeve and other components of the combustor to vibrate and otherwise move with respect to one another. In particular, the combustion liner typically thermally deforms and vibrates with respect to the flow sleeve. As such, wear is often exhibited on the liner stops as a result of such deformation and/or vibration. This can lead to failure of the liner stop tab and/or the liner stop block, thereby resulting in misalignment of the combustion liner within the flow sleeve and/or damage to the combustion liner or flow sleeve.

To prevent such failure, it has been disclosed that the entire liner stop block of a combustor may be formed from a hardened alloy designed to reduce the amount of wear occurring between the liner stop block and the liner stop tab. However, to include such a liner stop block within an existing combustor, the pre-existing liner stop block must be removed from the flow sleeve, which can present several problems. In particular, removal of the existing liner stop block requires that a maintenance worker drill out the liner stop block from the flow sleeve, which can be a very labor intensive and timing consuming process. Moreover, removal of the original stop block effectively eliminates any of the locating features that were incorporated into the original design for aligning the liner stop block to the flow sleeve. As such, installation of the new liner stop block is often more difficult and can lead to misalignment of the liner stop block to the flow sleeve. Furthermore, both the existing and replacement liner stop blocks are often formed from relatively expensive alloys. As such, completely replacing a liner stop block can result in increased material costs.

Accordingly, a combustion liner stop block having insertable wear features and a method for installing such features within a liner stop block would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter discloses methods for installing wear features within a combustion liner stop block. The methods may generally include enlarging a slot defined in the liner stop block to form a cavity, locating an insert block in the cavity and providing at least one wear feature associated with the insert block.

In another aspect, the present subject matter discloses a combustion liner stop block for a combustor. The liner stop block may generally include an outer block defining a cavity and an insert block disposed in the cavity. The insert block may define a channel configured to receive a mating component of the liner stop block. Additionally, the liner stop block may include at least one wear feature associated with the insert block.

In a further aspect, the present subject matter discloses a combustor including a combustion casing, a flow sleeve and a combustion liner substantially concentrically arranged within the flow sleeve. The combustor may also include at least one liner stop tab secured to one of i) the flow sleeve ii) the combustion liner and iii) the combustion casing and at least one liner stop block secured to one other of i) the flow sleeve, ii) the combustion liner and iii) the combustion casing. The liner stop block may generally be configured to engage the liner stop tap. Additionally, the liner stop block may include an outer block defining a cavity, an insert block disposed in the cavity and at least one wear feature associated with the insert block.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a cross-sectional side view of an embodiment of a gas turbine combustor;

FIG. 2 illustrates a perspective view of embodiments of a combustion liner stop block and a combustion liner stop tab;

FIG. 3 illustrates a flow chart providing one embodiment of a method for installing wear features within a combustion liner stop block in accordance with aspects of the present subject matter;

FIG. 4 illustrates a perspective view of embodiments of a combustion liner stop block and an insert block that may be inserted into the liner stop block in accordance with aspects of the present subject matter;

FIG. 5 illustrates a perspective view of the embodiments of the combustion liner stop block and the insert block shown in FIG. 4, particularly illustrating the insert block defining an elongated channel and being secured within the liner stop block in accordance with aspects of the present subject matter;

FIG. 6 illustrates a perspective view of an embodiment of a wear feature that may be inserted into an embodiment of an insert block in accordance with aspects of the present subject matter; and

FIG. 7 illustrates a perspective view of one embodiment of an assembled combustion liner stop block including insertable wear features in accordance with aspects of the present subject matter.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

The present subject matter is generally directed to a combustion liner stop block including insertable wear features and a method for installing such wear features within a liner stop block. For example, the disclosed liner stop block generally includes an insert block having one or more associated wear features configured to reduce the amount of wear occurring between the liner stop block and the liner stop tab. By associating such wear features with the disclosed insert block, the need to replace the original liner stop block is eliminated. In particular, a cavity may be formed within the original stop block which is configured to receive the insert block and associated wear features. Accordingly, the costs associated with removing the liner stop block, such as labor and material costs, can be eliminated. Additionally, by utilizing the original liner stop block, the precise location of the stop block achieved during original installation may be maintained. Moreover, the insert block of the present subject matter may be configured to have a standardized size and/or shape such that it may be used in a wide range of different gas turbines having liner stop blocks including varying sizes, shapes and/or configurations.

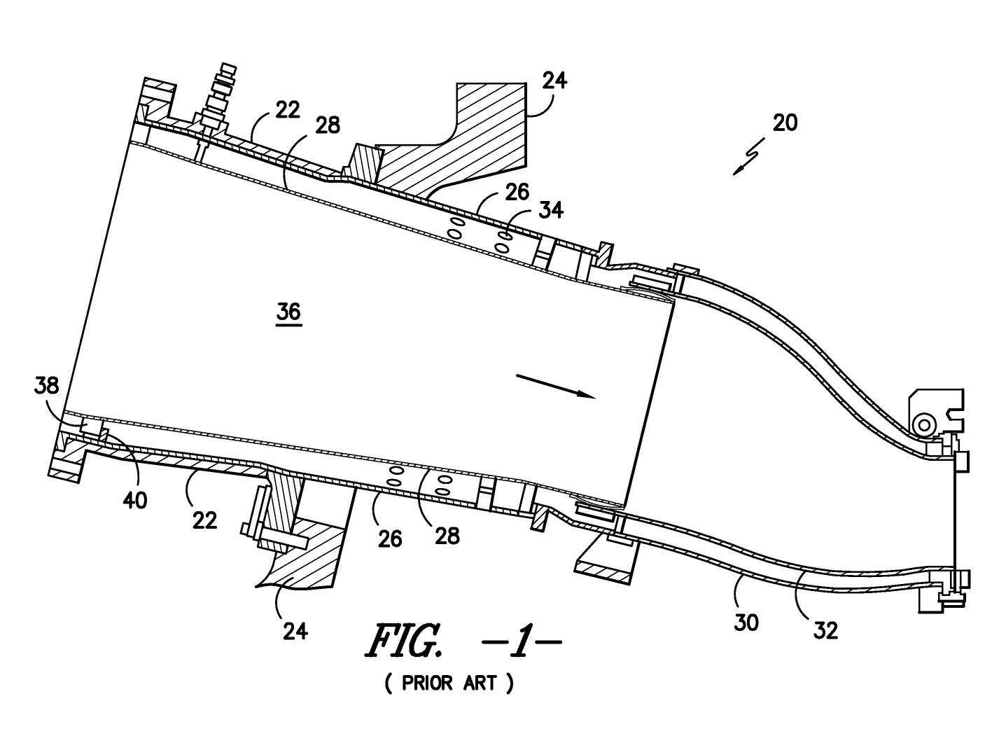

Referring now to the drawings, FIG. 1 illustrates a cross-sectional side view of an embodiment of a gas turbine combustor 20. The combustor 20 may generally include a substantially cylindrical combustion casing 22 secured to a portion of a gas turbine casing 24, such as a compressor discharge casing or a combustion wrapper casing. The combustor 20 may also include an internal flow sleeve 26 and a combustion liner 28 substantially concentrically arranged within the flow sleeve 26. Both the flow sleeve 26 and the combustion liner 28 may extend, at their downstream ends, to a double walled transition duct, including an impingement sleeve 30 and a transition piece 32 disposed within the impingement sleeve 30. However, it should be appreciated that some gas turbines may only include a single-wall transition duct. Additionally, the impingement sleeve 30 and the flow sleeve 26 may be provided with a plurality of air supply holes 34 over a portion of their surfaces, thereby permitting pressurized air from the compressor section of a gas turbine to enter the radial space between the combustion liner 28 and the flow sleeve 26.

The combustion liner 28 of the combustor 20 may generally define a substantially cylindrical combustion chamber 36, wherein fuel and air are injected and combusted to produce hot gases of combustion. Additionally, the combustion liner 28 may be coupled at its downstream end to the transition piece 32 such that the combustion liner 28 and the transition piece 32 generally define a flow path for the hot gases of combustion flowing from each combustor 20 to the turbine section of a gas turbine.

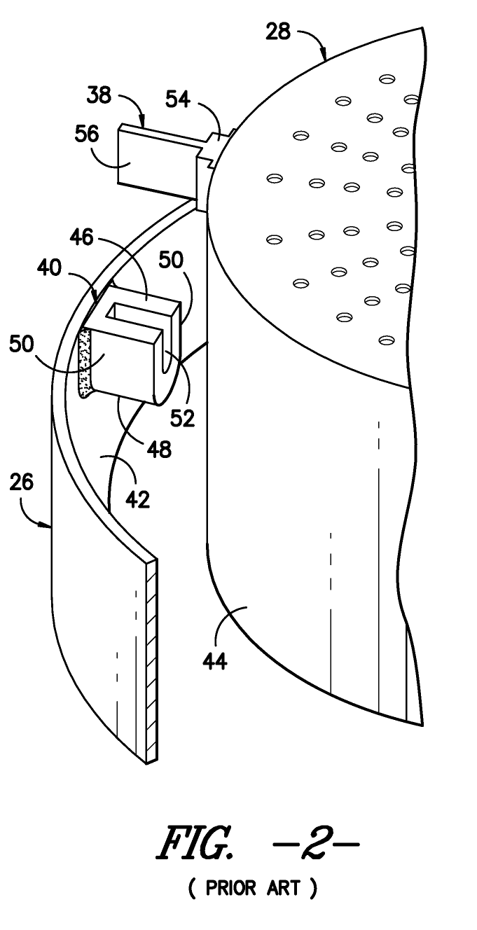

The combustion liner 28 may also include one or more male liner stop tabs 38 configured to mate with or otherwise engage one or more female liner stop blocks 40 secured to the flow sleeve 26 or, in some embodiments, the combustion casing 22. In particular, the liner stop tabs 38 may be adapted to slide into an elongated slot 52 (FIG. 2) defined within the liner stop blocks 40 as the combustion liner 28 is installed in the combustor 20 so as to ensure proper circumferential alignment of the liner 28 within the flow sleeve 26. Additionally, the liner stops 38, 40 may be also utilized to indicate the proper installation depth of the combustion liner 28 as well as prevent rotation and/or axial movement of the liner 28 during operation of the combustor 20. It should be appreciated that, in alternative embodiments, the liner stops tabs 38 may be disposed on the flow sleeve 26 or the combustion casing 22 while the liner stop blocks 40 may be disposed on the combustion liner 28.

Referring now to FIG. 2, perspective views of embodiments of a combustion liner stop tab 38 and combustion liner stop block 40 are illustrated. Generally, the liner stop block 40 may be secured to an inner surface 42 of the flow sleeve 26. However, as indicated above, in some embodiments, the liner stop block 40 may be secured to an inner surface of the combustion casing 22. Additionally, the liner stop tab 38 may be secured to an outer surface 44 of the combustion liner 28. It should be appreciated that the liner stop block 40 and stop tab 38 may be secured to the flow sleeve 26 and combustion liner 28, respectively, using any suitable means known in the art. For example, as shown in FIG. 2, the liner stop block 40 may be welded to the inner surface 42 of the flow sleeve 26. The liner stop block 40 may also include a pin, rod or other mounting feature (not illustrated) extending through the flow sleeve 26 to provide a further attachment mechanism between the stop block 40 and the flow sleeve 26. Similarly, the liner stop tab 38 may be welded to the outer surface 44 of the combustion liner 28. However, it should be appreciated that, in alternative embodiments, the liner stops 38,40 may be secured to their respective combustor components using a suitable attachment mechanism, such as by using screws, bolts or any other known mechanical fastener.

In general, it should be appreciated that the liner stop block 40 and the liner stop tab 38 may be designed to have any suitable shape and/or configuration that enables the liner stop tab 38 to mate and/or engage with the liner stop block 40 so as to facilitate installation of the combustion liner 28 and/or to properly align the combustion liner 28 within the flow sleeve 26 (or combustion casing 22) and/or to prevent rotation and/or axial movement of the liner 28 during operation of the combustor 20. For example, in the embodiment illustrated in FIG. 2, the liner stop block 40 may comprise a substantially planar or flat end 46, a rounded or curved end 48, and a pair of side walls 50 extending between the flat end 46 and the curved end 48. The liner stop block 40 may also define an elongated slot 52 configured to receive the liner stop tab 38. The elongated slot 52 may generally be defined from the flat end 46 of the liner stop block 40 and may extend in the direction of the curved end 48. Additionally, as shown in FIG. 2, the liner stop tab 38 may generally comprise a base 54 and a substantially rectangular protrusion 56 extending from the base 54 such that the liner stop tab 38 may slide into and engage the liner stop block 40 as the combustion liner 28 is installed within the flow sleeve 26. It should be appreciated that, although a single set of liner stops 38,40 is illustrated in FIG. 2, two, three or more sets of liner stops 38,40 may be included within each combustor 20.

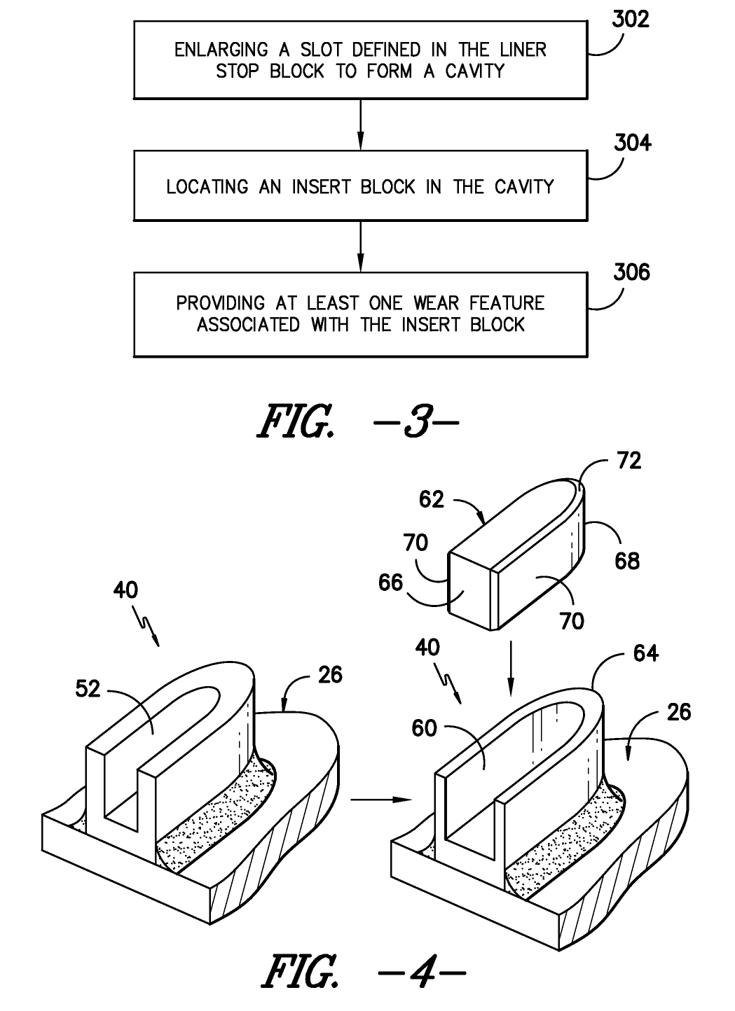

As indicated above, the present subject matter is generally directed to a liner stop block having insertable wear features and a method for installing wear features within a liner stop block. Thus, one embodiment of the disclosed method will generally be described with reference to FIG. 3 and will be explained in greater detail with reference to FIGS. 4-7. Additionally, various embodiments of the disclosed liner stop block will also be described with reference to FIGS. 4-7.

Thus, referring to FIG. 3, one embodiment of a method for installing wear features within a combustion liner stop block is illustrated. Generally, the method includes enlarging a slot defined in the liner stop block to form a cavity 302, locating an insert block in the cavity 304 and providing at least one wear feature associated with the insert block 306. As indicated above, the disclosed method may generally permit wear features to be installed within a liner stop block without necessitating the removal of the existing stop block. As such, the method will generally be described herein with reference to installing wear features into new and used liner stop blocks that were not originally designed to include such features. However, it should be appreciated that the disclosed method may also be used to quickly and efficiently install new wear features into liner stop blocks that did, in fact, initially include one or more wear features. It should also be appreciated that, although the various elements 302, 304, 306 of the disclosed method are illustrated in a particular order in FIG. 3, the elements may generally be performed in any sequence and/or order consistent with the disclosure provided herein.

Referring now to FIG. 4, there is illustrated perspective views of embodiments of a liner stop block 40 attached to a portion of a flow sleeve 26 of a combustor 20 (FIG. 1). In particular, FIG. 4 illustrates embodiments of the liner stop block 40 before and after it has been enlarged to define a cavity 60 in accordance with aspects of the present subject matter. Thus, initially, the liner stop block 40 may generally define an elongated slot 52 which, as indicated above, may be configured to accommodate a corresponding liner stop tab 38 (FIG. 2). However, as shown in FIG. 4, an enlarged cavity 60 may be formed within the liner stop block 40 by machining or otherwise removing material from the stop block 40 in the area adjacent to the elongated slot 52. Accordingly, in one embodiment, the cavity 60 may define a larger volume than the volume defined by the elongated slot 52. In general, the cavity 60 may be formed in the liner stop block 40 such that an insert block 62 may be inserted into or otherwise disposed within the cavity 60. As such, the liner stop block 40 may generally serve as an outer block 64 for receiving the insert block 62. It should be appreciated that the cavity 60 may be formed using any suitable means known in the art. For example, various known machining processes, such as milling processes, drilling processes, other precision machining processes and the like, may be utilized to form the cavity 60 within the liner stop block 40.

In general, the insert block 62 and cavity 60 may be designed to have any suitable shape and/or configuration that permits such components to function as described herein. For example, in one embodiment, the insert block 62 may be configured substantially similar to that of the liner stop block 40. Thus, in the illustrated embodiment, the insert block 62 may include a substantially planar or flat end 66, a rounded or curved end 68, and a pair of side walls 70 extending between the flat end 66 and the curved end 68. Additionally, as shown in FIG. 4, the cavity 60 may define a corresponding shape so that the insert block 62 may be received therein. However, in alternative embodiments, it should be appreciated that the insert block 62 and corresponding cavity 60 may be substantially rectangular in shape or may otherwise define any other suitable shapes and/or cross-sections. It should also be appreciated that the insert block 62 may generally be formed from any suitable material. However, in a particular embodiment, the insert block 62 may be formed from a relatively inexpensive metal, such as carbon steel.

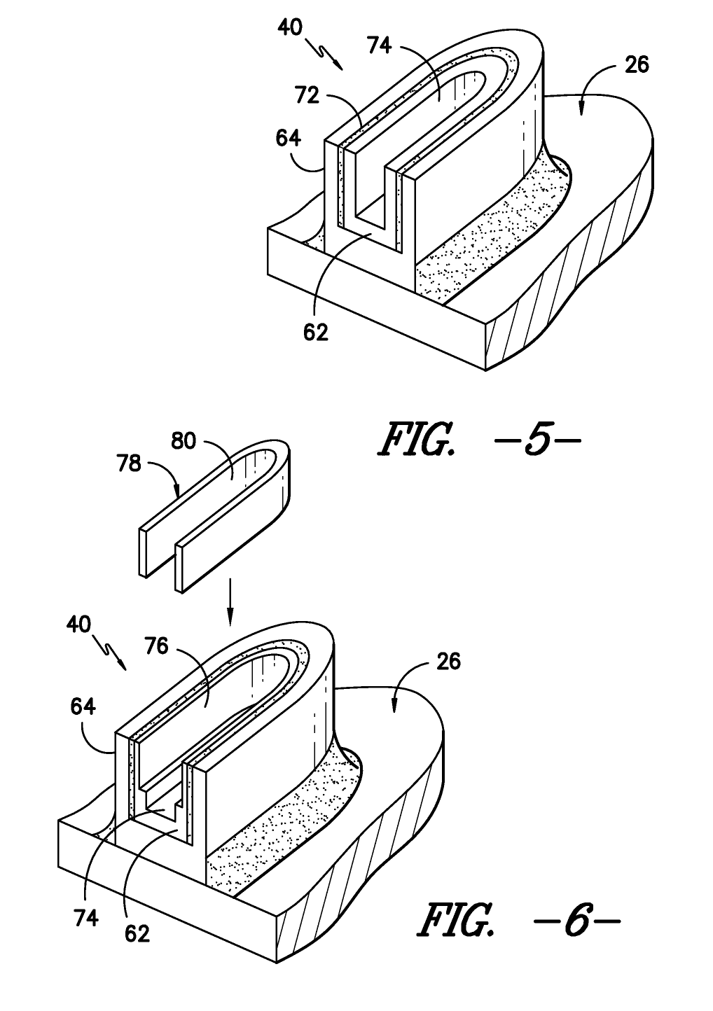

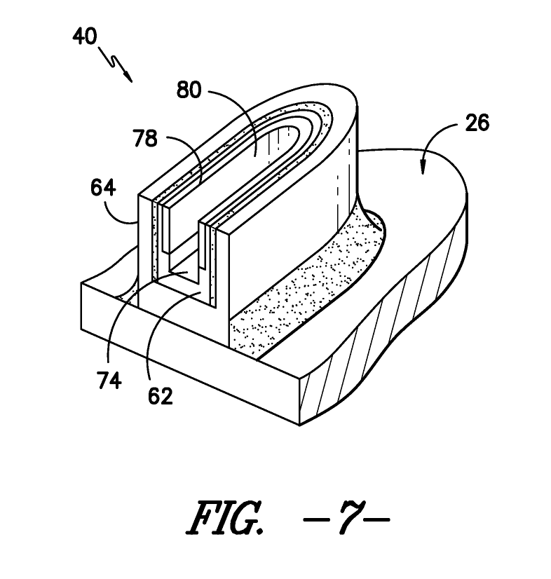

Referring still to FIG. 4, the insert block 62 may also be configured to be secured within the cavity 60 using any suitable means known in the art. For example in one embodiment, the insert block 62 may be configured to be welded to the liner stop block 40. In such an embodiment, the insert block 62 may define one or more weld preparation features configured to aid in welding the insert block 62 to the liner stop block 40. For instance, as shown, the insert block 62 may define a chamfered or beveled edge 72 along portions of its outer perimeter. Other suitable weld preparation features may include grooves, ridges, notches, and the like. In alternative embodiments, the insert block 62 may be configured to be secured within the cavity 60 using mechanical fasteners, such as by using bolts or screws, or using any other suitable attachment mechanisms and/or processes known the art. Additionally, it should be appreciated that, when inserted into the liner stop block 40, the insert block 62 need not be configured as a blank (e.g., a solid block of material) as is illustrated in FIG. 4. For example, in alternative embodiments, the insert block 62 may include machined features, such as the channel 74 and/or recessed area 76 described with reference to FIGS. 5 and 6, and/or may include one or more wear features prior to being inserted into the liner stop block 40.

Referring now to FIG. 5, there is illustrated a perspective view of one embodiment of the insert block 62 secured within the cavity 60 of the liner stop block 40. In particular, the insert block 62 is shown as being welded to the liner stop block 40 along the beveled edge 72 defined at the interface of the insert block 62 and the liner stop block 40. Moreover, as shown in FIG. 5, a channel 74 may be formed within the insert block 62 such that the liner stop tab 38 (FIG. 2) of the combustion liner 28 may be received within the channel 74 as the combustion liner 28 is installed within the flow sleeve 26. In general, it should be appreciated that the channel 74 may be formed within the insert block 62 so as to define any suitable shape and/or cross-section. However, in a particular embodiment of the present subject matter, the channel 74 may define the same size, shape and/or dimensions as the elongated slot 52 (FIG. 4) defined within the liner stop block 40.

It should be appreciated that the channel 74 may be formed using any suitable means. For example, various known machining processes, such as milling processes, drilling processes, other precision machining processes and the like, may be utilized to form the channel 74 within the insert block 62. Additionally, as indicated above, the channel 74 may be formed before or after the insert block 62 is inserted into and/or secured to the liner stop block 40. For example, the insert block 62 may be pre-machined or otherwise formed (e.g., by a molding process) so that the channel 74 is defined within the insert block 62 prior to the block 62 being inserted into the liner stop block 40.

Referring now to FIG. 6, there is illustrated one embodiment of a wear feature that may be included within the insert block 62 in accordance with aspects of the present subject matter. As shown, the wear feature comprises a wear shim or wear strip 78 that may generally be configured to reduce the amount of wear occurring between the liner stop block 40 and the liner stop tab 38. In particular, the wear strip 78 may be formed from any suitable wear-resistant material capable of preventing or reducing wear between the liner stop block 40 and the liner stop tab 38. For example, suitable materials that may be used to form the wear strip 78 may include cobalt-based alloys, such as FSX-14 and L-605, nickel-based alloys, other hardwearing/hardfacing materials, and the like.

In an alternative embodiment, it should be appreciated that the wear feature of the present subject matter may comprise a wear resistant coating that may be applied to the surface of the channel 74 defined in the insert block 62 using any suitable process, such as by welding, metal spraying, thermal spraying, diffusion processes, and the like. Suitable wear resistant coatings may include, but are not limited to, coatings comprising one or more of the following materials: chromium carbide, tungsten, cobalt, STELLITE 6 alloy, any suitable hardwearing/hardfacing material, and/or any other materials that, when applied to the channel 74, may increase the wear resistance of the insert block 62. In another embodiment, the entire insert block 62 may be formed from a wear resistant material. In such an embodiment, the insert block 62, itself, may serve as the wear feature of the present subject matter. Suitable wear resistant materials may include cobalt-based alloys, such as FSX-14 and L-605, nickel-based alloys, other hardwearing/hardfacing materials, and the like.

Referring still to FIG. 6, in embodiments in which the wear feature comprises a wear strip 78, the wear strip 78 may generally be configured to have any suitable shape and/or configuration that permits the strip 78 to be inserted into or otherwise disposed within the insert block 62. The wear strip 78 may also be configured so as to define an elongated opening 80. For example, in one embodiment, the opening 80 may be substantially shaped, sized and/or dimensioned similarly to the channel 74 defined within the insert block 62 and/or the slot 52 (FIG. 4) defined within the liner stop block 40. As such, it should be appreciated that the opening 80 may be adapted to engage with or otherwise receive the liner stop tab 38 (FIG. 2) of the combustion liner 28 as the combustion liner 28 is installed within the flow sleeve 26. Accordingly, the wear strip 78 may generally serve as the interface between the insert block 62 and the liner stop tab 38 and, thus, may reduce the amount of wear occurring between the liner stop block 40 and the liner stop tab 38 during operation of the combustor 20.

Moreover, in one embodiment, a recessed area 76 may be defined within the channel 74 of the insert block 62 and may be configured to accommodate the wear strip 78. Thus as shown in FIG. 6, a recessed area 76 may be formed within the insert block 62 by machining or otherwise removing material from the insert block 62 such that at least a portion of the channel 74 is enlarged or otherwise widened. In one embodiment, the recessed area 76 may generally be shaped, sized or otherwise configured to have substantially the same shape, size and/or dimensions of the wear strip 78. For example, as shown in FIG. 7, the recessed area 76 may be formed so that, when the wear strip 78 is inserted into insert block 62, the wear strip 78 is positioned substantially flush with the portion of the channel 74 not enlarged or otherwise widened by the formation of the recessed area 76. It should be appreciated that the recessed area 76 may be formed using any suitable means. For example, various known machining processes, such as milling processes, drilling processes, other precision machining processes and the like, may be utilized to form the recessed area 76 within the insert block 62. It should also be appreciated that, in alternative embodiments, a recessed area 76 need not be defined within insert block 62. For example, the channel 74 may be formed within the insert block 62 so as to define appropriate dimensions for receiving the wear strip 78.

Referring now to FIG. 7, there is illustrated one embodiment of an assembled combustion liner stop block 40 having insertable wear features in accordance with aspects of the present subject matter. As shown, the combustion liner stop block 40 generally includes an outer block 64, an insert block 62 and a wear strip 78, each of which may generally be configured as described above. Thus, the outer block 64 may be configured to be secured to a portion of the flow sleeve 26, or, as the case may be, the combustion casing 22 of a combustor 20 (FIG. 1). Additionally, the outer block 64 may generally define a cavity 60 (FIG. 4) for receiving the insert block 62. As shown, the insert block 62 may generally include a recessed area 76 (FIG. 6) within a channel 74 for receiving the wear strip 78. Further, the wear strip 78 may be configured to fit within the recessed area 76 and may define an elongated opening 80 configured to receive the liner stop tab 38 (FIG. 2) of the combustion liner 28. As such, the wear strip 78 may serve as the interface between the liner stop block 40 and the liner stop tab 38 and, thus, may reduce the amount of wear occurring between such components.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for installing wear features within a combustion liner stop block defining a slot configured to receive a combustion liner stop tab, the method comprising:
enlarging the slot defined in the liner stop block to form a cavity;
locating an insert block in the cavity; and
providing at least one wear feature associated with the insert block.

2. The method of claim 1, further comprising forming a channel in the insert block before or after the insert block is located in the cavity.

3. The method of claim 2, wherein the channel has substantially the same dimensions as the slot defined in the liner stop block so that the liner stop tab may be received within the channel.

4. The method of claim 2, further comprising inserting the at least one wear feature in the channel before or after the insert block is located in the cavity.

5. The method of claim 2, further comprising modifying the channel to form a recessed area in the insert block.

6. The method of claim 5, wherein the at least one wear feature is disposed in the recessed area.

7. The method of claim 1, wherein the at least one wear feature comprises a wear strip, the wear strip being formed from a wear resistant material.

8. The method of claim 7, wherein the wear strip is disposed within the insert block such that the liner stop tab contacts the wear strip when the liner stop tab is received in the liner stop block.

9. The method of claim 1, wherein the at least one wear feature comprises a wear resistant coating applied to the insert block.

10. The method of claim 1, further comprising securing the insert block to the liner stop block.

11. The method of claim 10, wherein securing the insert block to the liner stop block comprises welding the insert block to the liner stop block, the insert block defining at least one weld preparation feature at an interface of the insert block and the liner stop block

12. A liner stop block for a combustor, the liner stop block comprising:
an outer block defining a cavity;
an insert block disposed in the cavity, the insert block defining a channel configured to receive a mating component of the liner stop block; and
at least one wear feature associated with the insert block.

13. The liner stop block of claim 12, wherein the at least one wear feature comprises a wear strip, the wear strip being formed from a wear-resistant material.

14. The liner stop block of claim 13, wherein the insert block further defines a recessed area within the channel, the wear strip being disposed in the recessed area.

15. The liner stop block of claim 12, wherein the at least one wear feature comprises a wear resistant coating applied to the channel.

16. The liner stop block of claim 12, wherein the insert block defines at least one weld preparation feature.

17. A combustor, comprising:
a combustion casing;
a flow sleeve at least partially disposed within the combustion casing;
a combustion liner substantially concentrically arranged within the flow sleeve;
at least one liner stop tab secured to one of i) the flow sleeve ii) the combustion liner and iii) the combustion casing; and
at least one liner stop block secured to one other of i) the flow sleeve ii) the combustion liner and iii) the combustion casing, the at least one liner stop block being configured to engage the at least one liner stop tab, the liner stop block comprising:
an outer block defining a cavity;
an insert block disposed in the cavity, the insert block defining a channel configured to receive the at least one liner stop tab; and
at least one wear feature associated with the insert block.

18. The liner stop block of claim 17, wherein the at least one wear feature comprises a wear strip, the wear strip being formed from a wear-resistant material.

19. The liner stop block of claim 18, wherein the insert block further defines a recessed area within the channel, the wear strip being disposed in the recessed area.

20. The liner stop block of claim 17, wherein the at least one wear feature comprises a wear resistant coating applied to the channel.
